(19) United States
(12) Patent Application Publication
(10) Pub. No.: US 2025/0139025 A1
(43) Pub. Date: May 1, 2025

(54) REMOTE COMPUTING APPARATUS AND DATA STORAGE SYSTEM COMPRISING THE SAME

(71) Applicant: SEOUL NATIONAL UNIVERSITY R&DB FOUNDATION, Seoul (KR)

(72) Inventors: Jaejin LEE, Seoul (KR); Junsik SHIN, Seoul (KR); Heehoon KIM, Seoul (KR)

(73) Assignee: SEOUL NATIONAL UNIVERSITY R&DB FOUNDATION, Seoul (KR)

(21) Appl. No.: 18/931,916

(22) Filed: Oct. 30, 2024

(30) Foreign Application Priority Data
Oct. 31, 2023 (KR) 10-2023-0147969
Oct. 30, 2024 (KR) 10-2024-0151195

(51) Int. Cl. G06F 13/16

(52) U.S. Cl. CPC G06F 13/1668; G06F 2213/16

(57) ABSTRACT

A remote computing apparatus communicating with a local computing apparatus is disclosed. The apparatus includes a communication interface, a storage device, a memory in which a driver of the storage device is executed, and a processor that stores data and metadata associated with the data in the storage device. The driver receives input/output commands for the storage device from the local computing apparatus through the communication interface, the processor processes the received input/output commands for the storage device using a plurality of queues, and the driver provides a result of processing the input/output commands to the local computing apparatus through the communication interface. By providing this apparatus, latency of remote memory operations can be reduced.

### CROSS-REFERENCE TO RELATED APPLICATIONS

This application claims priority to and the benefit of Korean Patent Application No. 10-2024-0151195 filed in the Korean Intellectual Property Office on Oct. 30, 2024, which claims priority to Korean Patent Application No. 10-2023-0147969 filed on Oct. 31, 2023. The entire contents of which are incorporated herein by reference.

### BACKGROUND OF THE INVENTION

### (a) Field of the Invention

The present disclosure relates to a remote computing apparatus and a data storage system, and more particularly, to a remote computing apparatus and a data storage system communicating with a local computing apparatus.

### (b) Description of the Related Art

A storage device driver is software or hardware for controlling various local nodes such as hard disk drives (HDDs) and solid state drives (SSDs) as well as storage devices in remote nodes.

A local computing apparatus in the prior art could perform a read operation or a write operation on a storage device located in a remote computing apparatus by transmitting metadata including a memory address to the remote computing apparatus and accessing the memory of the remote computing apparatus to read or write data.

Accordingly, there was a problem that a communication load occurred due to network communication between a local computing apparatus and a remote computing apparatus, and latency occurred in the time from when data was requested to when the data was actually transmitted.

The above-described information disclosed in the technology that is the background of this invention is intended solely to enhance the understanding of the background of the present invention, and therefore may include information that does not constitute prior art.

### SUMMARY

The present disclosure provides a remote computing apparatus and a data storage system that improves communication load and latency by arranging metadata required for memory operations in a remote node to solve the above-described problems.

However, technical objectives to be achieved by the present disclosure are not limited thereto, and other unmentioned technical objectives will be apparent to one of ordinary skill in the art from the description of the present disclosure.

The present disclosure may be implemented in a variety of ways, including a method, an apparatus (system), or a computer program stored in a computer-readable recording medium.

According to one embodiment of the present disclosure, a remote computing apparatus that communicates with a local computing apparatus includes: a communication interface; a storage device; a memory in which a driver of the storage device is executed; and a processor that stores data and metadata associated with the data in the storage device, wherein the driver is configured to receive input/output commands for the storage device from the local computing apparatus through the communication interface, the processor is configured to process the received input/output commands for the storage device using a plurality of queues, and the driver is further configured to provide a result of processing the input/output commands to the local computing apparatus through the communication interface.

According to one embodiment of the present disclosure, the driver is further configured to: receive a write command for writing data of a specific size to a specific address of the storage device from the local computing apparatus through the communication interface and add the write command to a submission queue, and while waiting for an execution response of the processor for the write command, receive at least a portion of the data of the specific size from the local computing apparatus through the communication interface and store it in a buffer.

According to one embodiment of the present disclosure, the driver is further configured to sequentially transmit data received in the buffer to the storage device when receiving an execution response of the processor for the write command, and the processor is further configured to store the sequentially transmitted data and associated metadata at a specific address of the storage device.

According to one embodiment of the present disclosure, the processor is further configured to share result information corresponding to the write command with the driver using a completion queue, and the driver is further configured to transmit the result information corresponding to the write command to the local computing apparatus through the communication interface.

According to one embodiment of the present disclosure, the driver is further configured to: receive a read command for reading data of a specific size at a specific address of the storage device from the local computing apparatus through the communication interface, add the read command to a submission queue, and provide metadata for the read command to the processor.

According to one embodiment of the present disclosure, the processor is further configured to share result information corresponding to the read command with the driver using a completion queue, and the driver is further configured to transmit data corresponding to the read command to the local computing apparatus through the communication interface.

According to one embodiment of the present disclosure, the driver is further configured to provide a transmission completion signal to the local computing apparatus through the communication interface when data transmission corresponding to the read command is completed.

According to one embodiment of the present disclosure, a data storage system includes a local computing apparatus; and a remote computing apparatus communicating with the local computing apparatus, the remote computing apparatus including: a communication interface; a storage device; a memory in which a driver of the storage device is executed; and a processor that stores data and metadata associated with the data in the storage device, the driver is configured to receive input/output commands for the storage device from the local computing apparatus through the communication interface, the processor is configured to process the received input/output commands for the storage device using a plurality of queues, and the driver is further configured to provide a result of processing the input/output commands to the local computing apparatus through the communication interface.

According to one embodiment of the present disclosure, the driver is further configured to receive a write command for writing data of a specific size to a specific address of the storage device from the local computing apparatus through the communication interface, add the write command to a submission queue, and while waiting for an execution response of the processor for the write command, receive at least a portion of the data of the specific size from the local computing apparatus through the communication interface and store it in a buffer.

According to one embodiment of the present disclosure, the driver is further configured to sequentially transmit data received in the buffer to the storage device when receiving an execution response of the processor for the write command, and the processor is further configured to store the sequentially transmitted data and associated metadata at a specific address of the storage device.

According to one embodiment of the present disclosure, the processor is further configured to share result information corresponding to the write command with the driver using a completion queue, and the driver is further configured to transmit the result information corresponding to the write command to the local computing apparatus through the communication interface.

According to one embodiment of the present disclosure, the driver is further configured to: receive a read command for reading data of a specific size at a specific address of the storage device from the local computing apparatus through the communication interface, add the read command to a submission queue, and provide metadata for the read command to the processor.

According to one embodiment of the present disclosure, the processor is further configured to share result information corresponding to the read command with the driver using a completion queue, and the driver is further configured to transmit data corresponding to the read command to the local computing apparatus through the communication interface.

According to one embodiment of the present disclosure, the driver is further configured to provide a transmission completion signal to the local computing apparatus through the communication interface when data transmission corresponding to the read command is completed.

According to one embodiment of the present disclosure, a data storage system includes a first FPGA (field programmable gate array) board; and a second FPGA board including a communication interface, a data buffer, a storage device, and a driver for controlling the storage device, wherein the data buffer stores data received through the communication interface, and the driver is further configured to manage input/output commands for the storage device using a plurality of queues, and provide information on a result of executing the input/output commands to the first FPGA board through the communication interface.

According to some embodiments of the present disclosure, when performing memory operations on a remote computing apparatus, metadata for the memory operation is stored in advance on the remote computing apparatus, thereby reducing communication load and latency.

However, the effects that can be obtained through the present invention are not limited to the effects described above, and other technical effects that are not mentioned can be clearly understood by those skilled in the art from the description of the invention described below.

### BRIEF DESCRIPTION OF DRAWINGS

The accompanying drawings illustrate preferred embodiments of the present disclosure and, together with the foregoing disclosure, serve to provide further understanding of the technical spirit of the present disclosure. Therefore, the present disclosure is not to be construed as being limited to the drawings.

FIG. 1 is a schematic diagram showing a network environment according to one embodiment of the present disclosure.

FIG. 2 is a block diagram showing a data storage system according to one embodiment of the present disclosure.

FIGS. 3 and 4 are diagrams for explaining the process of performing a data write operation on a remote computing apparatus according to an embodiment of the present disclosure.

FIGS. 5 and 6 are diagrams for explaining the process of performing a data read operation from a remote computing apparatus according to an embodiment of the present disclosure.

FIG. 7 is a diagram for explaining a data storage system 1000 using an FPGA according to an embodiment of the present disclosure.

The above and other objects, features and advantages of the present disclosure will be described with reference to the accompanying drawings described below, where similar reference numerals indicate similar elements, but not limited thereto, in which:

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “part” used herein refers to a software or hardware component, and “module” or “part” performs certain roles. However, the meaning of the “module” or “part” is not limited to software or hardware. The “module” or “part” may be configured to be in an addressable storage medium or configured to play one or more processors. Accordingly, as an example, the “module” or “part” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “parts” may be combined into a smaller number of components and “modules” or “parts”, or further divided into additional components and “modules” or “parts.”

The “module” or “part” may be implemented as a processor and a memory. The “processor” should be interpreted broadly to encompass a general-purpose processor, a Central Processing Unit (CPU), a microprocessor, a Digital Signal Processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, for example, a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. The memory is said to be in electronic communication with a processor if the processor can read information from and/or write information to the memory. The memory integrated with the processor is in electronic communication with the processor.

In the present disclosure, a “system” may refer to at least one of a server apparatus and a cloud apparatus, but aspects are not limited thereto. For example, the system may include one or more server apparatus. In another example, the system may include one or more cloud apparatus. In still another example, the system may include both the server apparatus and the cloud apparatus operated in conjunction with each other.

In the present disclosure, “each of a plurality of A” may refer to each of all components included in the plurality of A, or may refer to each of some of the components included in a plurality of A.

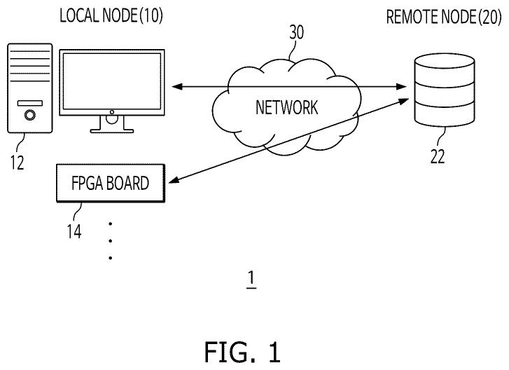

FIG. 1 is a schematic diagram showing a network environment 1 according to one embodiment of the present disclosure. The network environment 1 may include a local node 10, a remote node 20, and a network 30.

First, the nodes 10 and 20 may include physical devices or logical devices connected to the network 30 as communication entities in the network environment 1. The physical devices may include servers, computers, storage devices, routers, switches, printers, field-programmable gate array (FPGA) boards, and the like, and the logical devices may include virtual servers, cloud instances, and the like, but the present disclosure is not limited thereto.

The local node 10 may be a node located close to a user or a node that serves as a reference for a network process in a network. The local node 10 may include a computing apparatus 12, an FPGA board 14, a storage device, and the like, but the present disclosure is not limited thereto.

The remote node 20 is a node located remotely from the local node 10 and may include a computing apparatus, an FPGA board, a storage device 22, and the like, but the present disclosure is not limited thereto.

The network 30 may include various configurations and/or environments that allow two or more devices (for example, the local node 10 and the remote node 20) to be connected to each other to share data and resources.

In one embodiment, the local computing apparatus 12, which is the local node 10, may write data to the storage device 22, which is the remote node 20, or read data stored in the storage device 22.

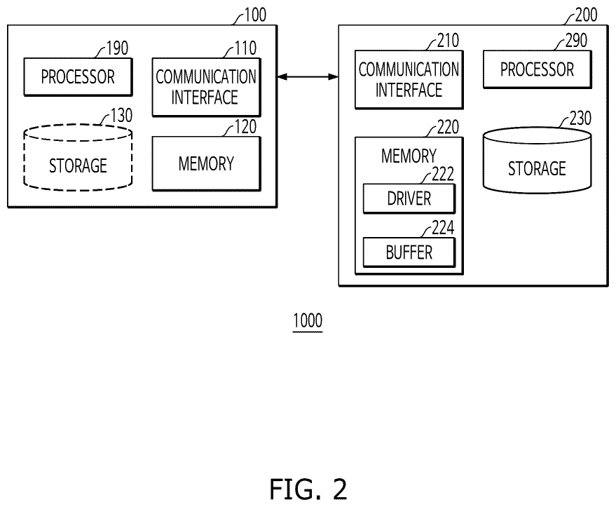

FIG. 2 is a block diagram illustrating a data storage system 1000 according to one embodiment of the present disclosure. The data storage system 1000 includes a local computing apparatus 100, which corresponds to a local node, and a remote computing apparatus 200, which corresponds to a remote node.

Hereinafter, the configuration of the local computing apparatus 100 and the remote computing apparatus 200 will be described first, and then the process for data input and/or output will be described.

The local computing apparatus 100 includes a communication interface 110, a memory 120, a processor 190, and may optionally include a storage device 130 (hereinafter referred to as “storage”).

The communication interface 110 may provide a configuration or function for the local computing apparatus 100 and the remote computing apparatus 200 to communicate with each other via a network. In one embodiment, the communication interface 110 may provide a request or data generated by the processor 190 of the local computing apparatus 100 according to the program code stored in the memory 120 to the remote computing apparatus 200 via the network. Conversely, the communication interface 110 may receive a control signal, command, data, and the like provided according to the control of the processor 290 of the remote computing apparatus 200.

The communication interface 110 may be configured to connect to a wired network such as Ethernet, a wired home network (power line communication), a telephone line communication device, and RS-serial communication, a wireless network such as a mobile communication network, WLAN (Wireless LAN), Wi-Fi, Bluetooth, and ZigBee, a broadcast network, a satellite network, and the like.

The memory 120 may temporarily store data while executing a program of the local computing apparatus 100 or processing a task, and may be implemented as a volatile memory, but the present disclosure is not limited thereto. The memory 120 may include a random access memory (RAM), a DRAM (dynamic RAM), an SRAM (static RAM), a cache memory, and the like, but the present disclosure is not limited thereto.

The storage 130 may store data for a long period of time, and may be implemented as a non-volatile memory, but the present disclosure is not limited thereto. In addition, the storage 130 may include an HDD, an SSD, a USB drive, and the like, but the present disclosure is not limited thereto.

The processor 190 may be configured to process commands of a computer program by performing basic arithmetic, logic, and input/output operations. The commands may be provided to the processor 190 by the communication interface 110 or the memory 120. For example, the processor 190 may be configured to execute commands received according to program code stored in a recording device such as the memory 120. The processor 190 may include a memory controller that controls the memory 120 and/or the storage 130.

The remote computing apparatus 200 may include a communication interface 210, a storage device 230 (hereinafter referred to as “storage”), a memory 220 in which a driver 222 of the storage device 230 is executed, and a processor 290 that stores data and metadata related to the data in the storage 230. The differences from the local computing apparatus 100 will be described below.

The processor 290 may store metadata necessary for performing an input/output request of the local computing apparatus 100 in the storage 230. The processor 290 may store a read address, a write address, namespace identification information, controller identification information, communication type information, target IP address and port information, information for secure connection, authentication mechanism information, subsystem type information, queue depth information, maximum data transfer size information, QoS-related information, bandwidth information, latency constraint information, error management information, and the like in the storage 230. The remote computing apparatus 200 may secure information in advance for the local computing apparatus 100 to perform an input/output request to the remote computing apparatus 200 by storing data and metadata associated with the data in advance. Accordingly, the number of communications can be reduced, and the latency due to the communication can be reduced.

In one embodiment, the processor 290 may store metadata in the storage 230, and the metadata may include at least one of information required to process a memory request (for example, including an address and a request size) or information indicating the number of memory requests.

In one embodiment, the processor 290 may store memory request processing information in the storage 230 when memory requests of different sizes occur at a plurality of addresses. In this case, unnecessary computational processes can be omitted, and the communication load and latency can be reduced. To explain an example of comparison, when a local computing apparatus performs a 100-byte read operation from address 0x1000, a 200-KB read operation from address 0x2000, and a 1-MB read operation from address 0x3000, the local apparatus transmits a 100-byte read request from address 0x1000 to a remote computing apparatus (step 1), transmits a memory request to check the next address (for example, 0x8000) of the linked list stored in the local computing apparatus (step 2), checks a 200-KB read request from address 0x2000 at address 0x8000 and transmits it to the remote computing apparatus (step 3), makes a request to the local computing apparatus again to check the next address (0x9000) of the linked list (step 4), and checks a 1-MB read request from address 0x3000 at address 0x9000 and transmits it to the remote computing apparatus (step 5). According to one embodiment of the present disclosure, steps 2 and 4 become unnecessary. Accordingly, unnecessary computational processes are omitted, and communication load and latency can be reduced.

In one embodiment, the processor 290 may store data indicating the number of memory requests as metadata in the storage 230. When the amount of communication is small, how often the communication occurs may have a significant impact on performance. For example, in an SSD storage device using the NVMe protocol, information indicating the number of memory requests may be only 4 bytes. In a situation where it may take hundreds of cycles (approximately 200 to 300 cycles) to transmit 4 bytes of data, if the data indicating the number of memory requests is stored in the remote computing apparatus, hundreds of cycles are saved, latency is reduced, and overall performance can be improved accordingly.

The memory 220 may include a driver 222 and a buffer 224 for controlling the storage 230, and the buffer 224 may temporarily store the received data.

The driver 222 may receive an input/output command for the storage device 230 from the local computing apparatus 100 through the communication interface 210.

The processor 290 may process the received input/output command for the storage 230 using a plurality of queues. The plurality of queues may include a submission queue and a completion queue.

Here, the submission queue is a queue for managing an input/output request to the storage 230 from the remote computing apparatus 200. The submission queue may provide an asynchronous processing function and may be implemented as a multi-queue. In addition, the submission queue may be controlled by the processor 290. In addition, the completion queue may be a queue for providing a result for the input/output request to the local computing apparatus 100 when the input/output request is completed. Since the submission queue and the completion queue are managed and controlled by the remote computing apparatus 200, the communication efficiency of the local computing apparatus 100 can be improved and the latency can be reduced.

The driver 222 may provide the processing result of the input/output command to the local computing apparatus 100 through the communication interface 210.

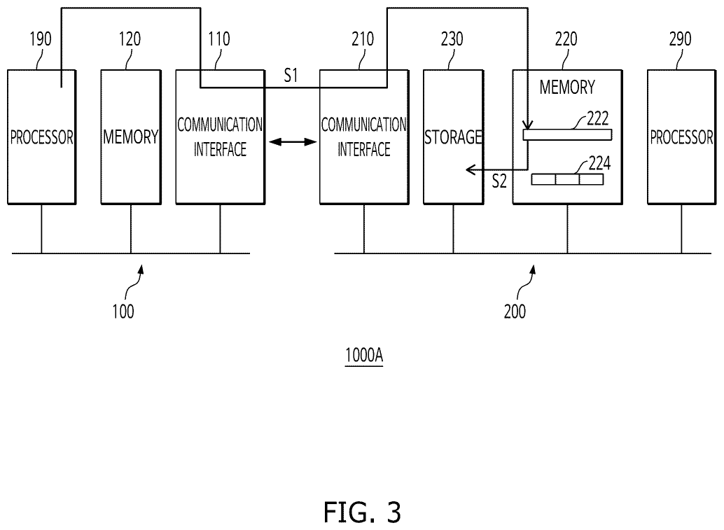

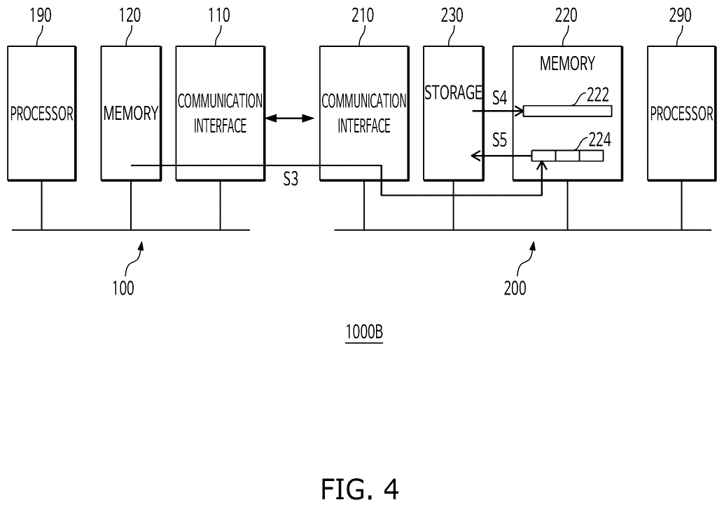

FIGS. 3 and 4 are diagrams for explaining the process of performing a data write operation on the remote computing apparatus 200 in a data storage system 1000A according to one embodiment of the present disclosure.

The driver 222 of the remote computing apparatus 200 may receive a write command for writing data of a specific size to a specific address of the storage 230 from the local computing apparatus 100 through the communication interface 210 (S1). Specifically, the processor 190 of the local computing apparatus 100 or the driver of the memory 120 may provide a write command to the communication interface 210 of the remote computing apparatus 200 via the communication interface 110.

The driver 222 or the processor 290 may add the write command to a submission queue. Here, the submission queue may be included in the memory 220.

The driver 222 may request a response from the processor 290 for the write command (S2). According to an implementation example, the driver 222 may receive a response from the processor 290 for the write command via the storage 230.

The driver 222 may receive at least a portion of data of a specific size from the local computing apparatus 100 through the communication interface 210 and store it in the buffer 224 while waiting for the execution response of the processor 290 for the write command (S3).

When the driver 222 receives the execution response of the processor 290 for the write command (S4), the driver 222 may sequentially transmit the data received in the buffer 224 to the storage device (S5). The driver 222 may monitor so that the data in the buffer 224 may be transmitted to the storage 230 without interruption. When data below a preset value is stored in the buffer 224, the driver 222 may request data transmission to the local computing apparatus 100 through the communication interface 210, but the present disclosure is not limited thereto.

In one embodiment, the processor 290 may store data and associated metadata sequentially transmitted to a specific address of the storage 230.

The processor 290 may share result information corresponding to the write command with the driver 222 using a completion queue. The completion queue may be stored in the memory 220.

The driver 222 may transmit result information corresponding to the write command to the local computing apparatus 100 through the communication interface 210 (S6). That is, the driver 222 may provide information on whether the write command was performed normally to the local computing apparatus 100.

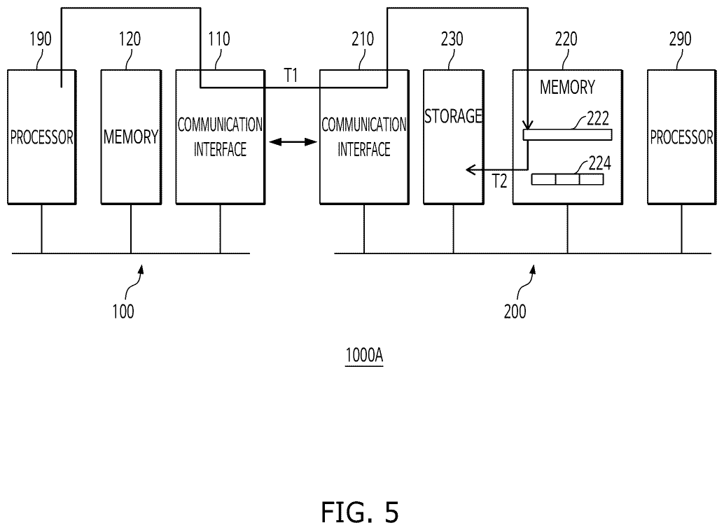

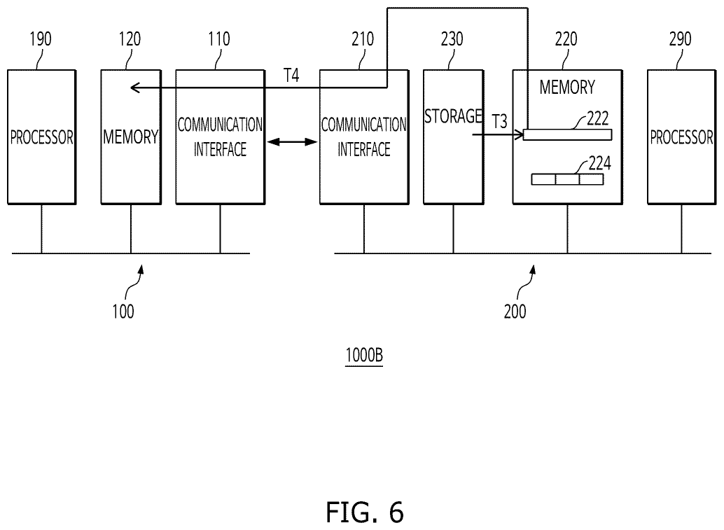

FIGS. 5 and 6 are diagrams for explaining the process of performing a data read operation from a remote computing apparatus of a data storage system 1000B according to one embodiment of the present disclosure.

The driver 222 may receive a read command to read data of a specific size from a specific address of the storage 230 from the local computing apparatus 100 through the communication interface 210 (T1). Specifically, the driver of the processor 190 or the memory 120 of the local computing apparatus 100 may provide the read command through the communication interface 110 to the communication interface 210 of the remote computing apparatus 200.

The driver 222 or the processor 290 may add the read command to a submission queue and provide metadata for the read command to the processor 290. The driver 222 may request an execution response of the processor 290 for the read command (T2). At this time, the driver 222 may receive the execution response of the processor 290 for the read command through the storage 230.

The processor 290 may share the result information corresponding to the read command with the driver 222 using a completion queue (T3).

The driver 222 may transmit the data corresponding to the read command to the local computing apparatus 100 through the communication interface 210 (T4). The driver of the processor 190 or memory 120 of the local computing apparatus 100 may obtain the data stored in the remote computing apparatus 200 through the communication interface 210.

In addition, the driver 222 may provide a transmission completion signal to the local computing apparatus 100 through the communication interface 210 when the data transmission corresponding to the read command is completed.

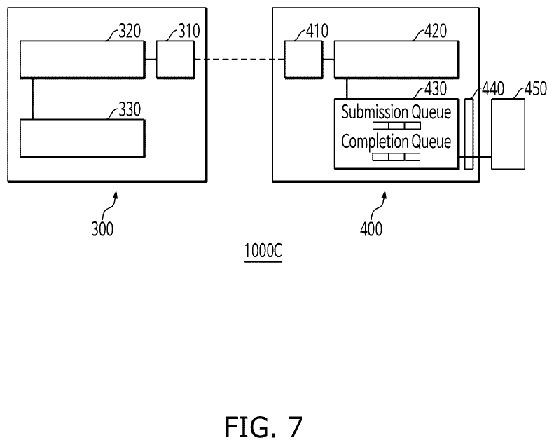

FIG. 7 is a diagram for explaining a data storage system 1000C using an FPGA board according to one embodiment of the present disclosure. The data storage system 1000C may include a first field programmable gate array (FPGA) board 300 and a second FPGA board 400.

The first FPGA board 300 may include a communication interface 310 (for example, a communication port), a data buffer 320 for transmitting data to the communication interface 310, and a driver 330. Here, the data buffer 320 and the driver 330 may be implemented as hardware, and the data buffer 320 may secure a response time of 1 cycle by using an on-chip memory such as BRAM or URAM. The driver 330 may be implemented as DDR4 RAM, but the present disclosure is not limited thereto.

The second FPGA board 400 may include a communication interface 410, a data buffer 420, a driver 430, an interface 440, and a storage 450. The storage 450 may be implemented as an NVMe SSD, but the present disclosure is not limited thereto. The interface 440 may be implemented as an OcuLink interface, and the communication between the components may use an AXI4 interface, but the present disclosure is not limited thereto. The data buffer 420 may store data received through the communication interface 410.

The driver 430 may manage input/output commands for the storage 450 using a plurality of queues. The plurality of queues may include a submission queue and a completion queue, and may be implemented in hardware.

The driver 430 may provide information on the execution result of the input/output command to the first FPGA board 300 through the communication interface 410.

The method illustrated in FIG. 7 can be sold as IP (intellectual property) through an FPGA, and the IP can be provided as a computer program stored in a computer-readable recording medium for execution on a computer. The medium may be a type of medium that continuously stores a program executable by a computer, or temporarily stores the program for execution or download. In addition, the medium may be a variety of writing means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and the like. In addition, other examples of the medium may include an app store that distributes applications, a site that supplies or distributes various kinds of software, and a recording medium or a storage medium managed by a server.

In addition, the above-described method may be applied to a deep learning-only appliance. When applied to a deep learning-only appliance, there is an advantage in that memory storage is not required.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality.

Whether such a function is implemented as hardware or software varies according to design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium.

For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in a plurality of processing chips or apparatus, and storage may be similarly influenced across a plurality of apparatus. Such apparatus may include PCs, network servers, and portable apparatus.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

### DESCRIPTION OF SOME REFERENCE SYMBOLS

100: Local computing apparatus
200: Remote computing

What is claimed is:

1. A remote computing apparatus that communicates with a local computing apparatus, comprising:
a communication interface;
a storage device;
a memory in which a driver of the storage device is executed; and
a processor that stores data and metadata associated with the data in the storage device, wherein
the driver is configured to receive input/output commands for the storage device from the local computing apparatus through the communication interface,
the processor is configured to process the received input/output commands for the storage device using a plurality of queues, and
the driver is further configured to provide a result of processing the input/output commands to the local computing apparatus through the communication interface.

2. The remote computing apparatus as claimed in claim 1, wherein
the driver is further configured to:
receive a write command for writing data of a specific size to a specific address of the storage device from the local computing apparatus through the communication interface and add the write command to a submission queue, and
while waiting for an execution response of the processor for the write command, receive at least a portion of the data of the specific size from the local computing apparatus through the communication interface and store it in a buffer.

3. The remote computing apparatus as claimed in claim 2, wherein
the driver is further configured to sequentially transmit data received in the buffer to the storage device when receiving an execution response of the processor for the write command, and
the processor is further configured to store the sequentially transmitted data and associated metadata at a specific address of the storage device.

4. The remote computing apparatus as claimed in claim 3, wherein
the processor is further configured to share result information corresponding to the write command with the driver using a completion queue, and
the driver is further configured to transmit the result information corresponding to the write command to the local computing apparatus through the communication interface.

5. The remote computing apparatus as claimed in claim 1, wherein
the driver is further configured to:
receive a read command for reading data of a specific size at a specific address of the storage device from the local computing apparatus through the communication interface,
add the read command to a submission queue, and
provide metadata for the read command to the processor.

6. The remote computing apparatus as claimed in claim 5, wherein
the processor is further configured to share result information corresponding to the read command with the driver using a completion queue, and
the driver is further configured to transmit data corresponding to the read command to the local computing apparatus through the communication interface.

7. The remote computing apparatus as claimed in claim 6,
the driver is further configured to provide a transmission completion signal to the local computing apparatus through the communication interface when data transmission corresponding to the read command is completed.

8. A data storage system, comprising:
a local computing apparatus; and
a remote computing apparatus communicating with the local computing apparatus, wherein
the remote computing apparatus comprising:
a communication interface;
a storage device;
a memory in which a driver of the storage device is executed; and
a processor that stores data and metadata associated with the data in the storage device, and wherein
the driver is configured to receive input/output commands for the storage device from the local computing apparatus through the communication interface,
the processor is configured to process the received input/output commands for the storage device using a plurality of queues, and
the driver is further configured to provide a result of processing the input/output commands to the local computing apparatus through the communication interface.

9. The data storage system as claimed in claim 8, wherein
the driver is further configured to:
receive a write command for writing data of a specific size to a specific address of the storage device from the local computing apparatus through the communication interface,
add the write command to a submission queue, and
while waiting for an execution response of the processor for the write command, receive at least a portion of the data of the specific size from the local computing apparatus through the communication interface and store it in a buffer.

10. The data storage system as claimed in claim 9, wherein
the driver is further configured to sequentially transmit data received in the buffer to the storage device when receiving an execution response of the processor for the write command, and
the processor is further configured to store the sequentially transmitted data and associated metadata at a specific address of the storage device.

11. The data storage system as claimed in claim 10, wherein
the processor is further configured to share result information corresponding to the write command with the driver using a completion queue, and
the driver is further configured to transmit the result information corresponding to the write command to the local computing apparatus through the communication interface.

12. The data storage system as claimed in claim 8, wherein
the driver is further configured to:
receive a read command for reading data of a specific size at a specific address of the storage device from the local computing apparatus through the communication interface,
add the read command to a submission queue, and
provide metadata for the read command to the processor.

13. The data storage system as claimed in claim 12, wherein
the processor is further configured to share result information corresponding to the read command with the driver using a completion queue, and
the driver is further configured to transmit data corresponding to the read command to the local computing apparatus through the communication interface.

14. The data storage system as claimed in claim 13, wherein
the driver is further configured to provide a transmission completion signal to the local computing apparatus through the communication interface when data transmission corresponding to the read command is completed.

15. A data storage system, comprising:
a first field programmable gate array (FPGA) board; and
a second FPGA board including a communication interface, a data buffer, a storage device, and a driver for controlling the storage device, wherein
the data buffer stores data received through the communication interface, and
the driver is further configured to manage input/output commands for the storage device using a plurality of queues, and provide information on a result of executing the input/output commands to the first FPGA board through the communication interface.
